(19) United States
(12) Patent Application Publication
(10) Pub. No.: US 2010/0333118 A1
(43) Pub. Date: Dec. 30, 2010

(54) EMBEDDED ELECTRONIC DEVICE AND METHOD FOR MANAGING MULTIMEDIA RESOURCE THEREIN

(75) Inventors: CHIA-HUNG CHIEN, Tu-Cheng (TW); CHUN-WEN WANG, Tu-Cheng (TW); LIANG-MAO HUNG, Tu-Cheng (TW); CHIH-YUAN CHUANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/579,256

(22) Filed: Oct. 14, 2009

(30) Foreign Application Priority Data
Jun. 25, 2009 (CN) 200910303652.1

(51) Int. Cl. G06F 9/46

(52) U.S. Cl. 719/329

(57) ABSTRACT

A method for managing multimedia resources in an embedded electronic device is disclosed. The method includes at least one graphical user interface (GUI) application module sending a multimedia resource request to an application programming interface (API) module. The API module provides a unified interface for the at least one GUI application module to retrieve the multimedia resources. The API module requests a source management module to connect to a plurality of multimedia resources. A plurality of multimedia sub-modules of the source management module retrieves the corresponding multimedia resources to the at least one GUI application module through the API module and displaying on a display.

### BACKGROUND

1. Technical Field

The present disclosure relates to an embedded electronic device and a method for managing multimedia resource therein.

2. Description of Related Art

Embedded devices, for example, digital photo frames (DPFs), are becoming increasingly popular due to their convenience and ease of manipulation when implementing particular functions. Furthermore, many types of files are stored in the embedded devices, and it can be a burden for users to handle these types of files.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of an embedded electronic device.

FIG. 2 is a schematic view of a method for managing multimedia resources of an embedded electronic device.

FIG. 3 is a flowchart of a method for managing multimedia resources of an embedded electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

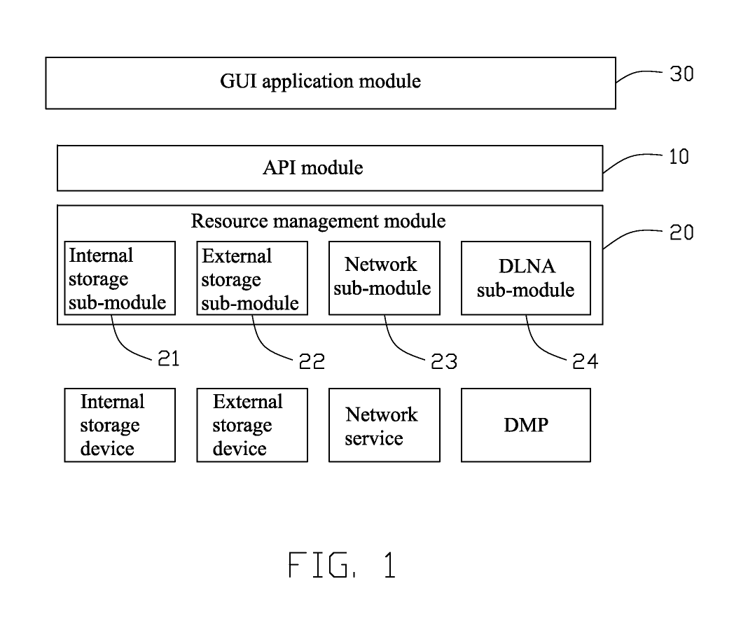

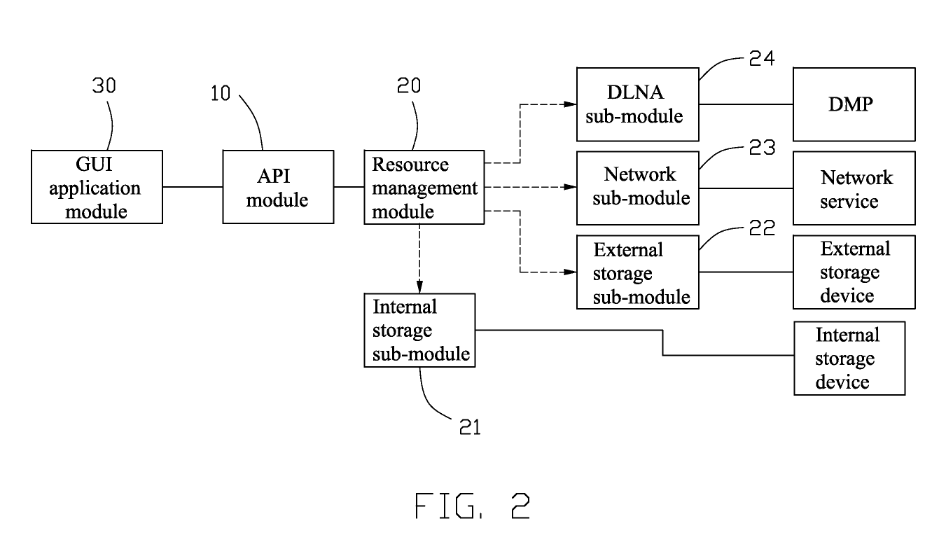

Referring to FIG. 1 and FIG. 2, an embedded electronic device includes an application programming interface (API) module 10, a source management module 20, a plurality of graphical user interface (GUI) application modules 30, and a display. The GUI application modules display GUIs on the display. The API module 10 provides a unified interface for communicating with the GUI application modules 30. The resource management module 20 includes a plurality of sub-modules to fetch multimedia resources. The GUI application module 30 may be a video GUI, a music GUI, or a photo GUI.

The API module 10 includes an insert sub-module, a delete sub-module, a query sub-module, and/or some other controlling sub-modules. When the GUI application module 30 sends an insert request to the API module 10, the API module 10 uses the insert sub-module to insert the multimedia resource for the GUI application module 30. The API module 10 sends a resource connection to the resource management module 20 to fetch the multimedia resource.

The resource management module 20 provides an internal storage sub-module 21 for fetching the multimedia resources from an internal storage system in the embedded electronic device. The internal storage system may be a flash memory capable of storing videos, music, and photos. The resource management module 20 provides an external storage sub-module 22 to fetch the multimedia resources. The external storage sub-module 22 may be a universal serial bus (USB) interface to connect to an external storage device, such as a portable hard disk.

The resource management module 20 provides a network sub-module 23 to fetch the multimedia resources from the network. The network sub-module 23 may be connected to web service, album service, or other services. The network sub-module 23 may be connected to a net file system (NFS) to fetch files. The network sub-module 23 may use hypertext transfer protocol (HTTP) or file transfer protocol (FTP).

The resource management module 20 provides a Digital Living Network Alliance (DLNA) sub-module 24 to fetch the multimedia resource. DLNA is a standard used by manufacturers of consumer electronics to allow entertainment devices within the home to share their content with each other across a home network. The DLNA sub-module 24 fetches the multimedia resource from a Digital Media Player (DMP).

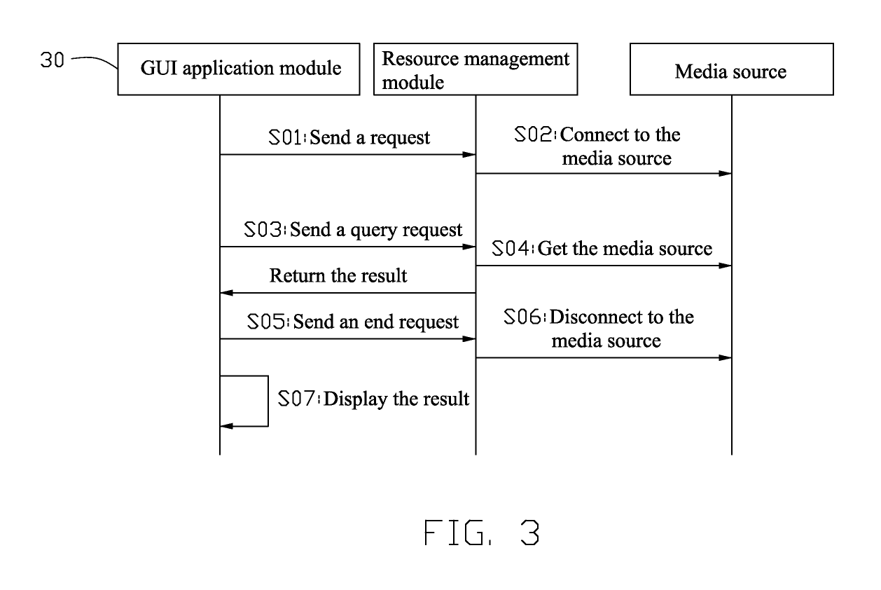

Referring to FIG. 3, a method for managing multimedia resources in an embedded electronic device includes the following steps.

In step S01 the GUI application module 30 sends a request to the resource management module 20 to fetch the multimedia resources through the API module 10.

In step S02, the resource management module 20 connects to the user specified media source.

In step S03, the GUI application module 30 sends a query request to the resource management module 20 to obtain the media source information. For example, the GUI application module 30 sends an identity of a singer of one song query request to the resource management module 20 to obtain the identity information. The GUI application module 30 may send an insert request to insert a song from the media source.

In step S04, the resource management module 20 sends a command to the media source to fetch the media source information and return the media source information to the GUI application module 30.

In step S05, the GUI application module 30 sends an end request to the resource management module 20. The resource management module 20 disconnects from the media source.

In step S06, the GUI application module 30 displays the media source information on the display of the embedded electronic device.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. A method for managing multimedia resources in an embedded electronic device, comprising:
providing an application programming interface (API) module, at least one graphical user interface (GUI) application module, a source management module, a plurality of multimedia sub-modules, and a unified interface for the at least one GUI application module to retrieve the multimedia resources by the API module;
sending a multimedia resource request to the API module through the at least one GUI application module;
requesting a source management module to connect to a plurality of multimedia resources via the API module;
retrieving the respective multimedia resources to the at least one GUI application module through the multimedia sub-modules of the source management module and displaying on a display.

2. The method of claim 1, wherein the API module comprises a plurality of function modules, the function modules are capable of managing the multimedia resources under the control of the GUI application module.

3. The method of claim 2, wherein the function module is one of an inserting sub-module, a deleting sub-module, a querying sub-module to manage the multimedia resources.

4. The method of claim 1, wherein the multimedia sub-modules comprise an internal storage sub-module capable of accessing an internal storage device.

5. The method of claim 1, wherein the multimedia sub-modules comprise an external storage sub-module capable of accessing an external storage device.

6. The method of claim 5, wherein the external storage device is a universal serial bus (USB) storage device.

7. The method of claim 1, wherein the multimedia sub-modules comprise a network sub-module capable of accessing network services.

8. The method of claim 7, wherein the network service is an Internet radio service.

9. The method of claim 1, wherein the multimedia sub-modules comprise a digital living network alliance (DLNA) sub-module capable of accessing DLNA sources.

10. The method of claim 9, wherein the DLNA source is a digital media player (DMP) source.

11. An embedded electronic device, comprising:
an application programming interface (API) module capable of providing a unified interface for the at least one GUI application module to retrieve the multimedia resources;
at least one graphical user interface (GUI) application module capable of sending a multimedia resource request to the API module;
the API module capable of requesting a source management module to connect to a plurality of multimedia resources;
a plurality of multimedia sub-modules of the source management module capable of retrieving the respective multimedia resources to the at least one GUI application module through the API module and displaying on a display.

12. The embedded electronic device of claim 11, wherein the API module comprises a plurality of function modules, the function modules are capable of managing the multimedia resources under the control of the GUI application module.

13. The embedded electronic device of claim 12, wherein the function module is one of an inserting sub-module, a deleting sub-module, and a querying sub-module to control the multimedia resources.

14. The embedded electronic device of claim 11, wherein one of the multimedia sub-modules is an internal storage sub-module capable of accessing an internal storage device.

15. The embedded electronic device of claim 11, wherein one of the multimedia sub-modules is an external storage sub-module capable of accessing an external storage device.

16. The embedded electronic device of claim 15, wherein the external storage device is a universal serial bus (USB) storage device.

17. The embedded electronic device of claim 11, wherein one of the multimedia sub-modules is a network sub-module capable of accessing network services.

18. The embedded electronic device of claim 17, wherein the network service is an Internet radio service.

19. The embedded electronic device of claim 11, wherein the multimedia sub-modules comprise a digital living network alliance (DLNA) sub-module capable of accessing DLNA sources.

20. The embedded electronic device of claim 19, wherein the DLNA source is a Digital Media Player (DMP) source.
